(19) United States
(12) Patent Application Publication
(10) Pub. No.: US 2015/0216384 A1
(43) Pub. Date: Aug. 6, 2015

(54) SEPARATING APPARATUS IN A VACUUM CLEANER

(71) Applicant: Dyson Technology Limited, Wiltshire (GB)

(72) Inventors: Andrew James BOWER, Shropshire (GB); Alejandro Ricardo Ortega Ancel, London (GB)

(73) Assignee: Dyson Technology Limited, Wiltshire (GB)

(21) Appl. No.: 14/610,678

(22) Filed: Jan. 30, 2015

(30) Foreign Application Priority Data
Jan. 31, 2014 (GB) 1401688.5

(51) Int. Cl. A47L 9/16; B01D 45/16; B01D 45/08

(52) U.S. Cl. CPC A47L 9/1608; B01D 45/08; B01D 45/16; A47L 9/1666; A47L 9/1683

(57) ABSTRACT

A vacuum cleaner comprising a vac motor and a separating apparatus for separating out dust particles entrained in an airflow drawn through the separator by the vac motor. The separating apparatus incorporates a non-cyclonic separation stage , the non-cyclonic separation stage comprising a flow bend for turning the airflow to separate out some of the dust particles entrained in the airflow, and a dust collector for collecting the dust particles separated out by the flow bend. The dust collector incorporates an opening, the flow bend being formed by a partition which divides the opening into a flow bend inlet and a flow bend outlet, the partition extending part-way into the dust collector so that airflow entering through the flow bend inlet is then forced to bend around the partition inside the dust collector before exiting through the flow bend outlet.

### REFERENCE TO RELATED APPLICATIONS

This application claims the priority of United Kingdom Application No. 1401688.5 filed 31 Jan. 2014, the entire contents of which are incorporated herein by reference.

### FIELD OF THE INVENTION

The present invention relates the field of vacuum cleaners, particularly to the design of separating apparatus used in vacuum cleaners.

### BACKGROUND OF THE INVENTION

Modern vacuum cleaners are typically either “bagged” or “bagless”.

Bagged machines can suffer loss of suction during use, which is caused by a progressive blocking of the pores of the filter bag with dust.

Bagless machines typically rely on cyclonic dust separation rather than a filter bag. These machines maintain much better suction than bagged machines, because cyclonic separators do not tend to block as easily as filter bags. But cyclonic separators are relatively complex in layout compared to a filter bag—which can make them difficult to package effectively in the machine. This difficulty increases with dual-stage cyclonic separating apparatus, which may require relatively complicated ducting paths to connect the two cyclonic stages making up the separating apparatus.

### SUMMARY OF THE INVENTION

The present invention provides a vacuum cleaner comprising a vac-motor and a separating apparatus for separating out dust particles entrained in an airflow drawn through the separating apparatus by the vac-motor, the separating apparatus comprising a non-cyclonic separation stage, the non-cyclonic separation stage comprising a flow bend for turning the airflow to separate out some of the dust particles entrained in the airflow, and a dust collector for collecting the dust particles separated out by the flow bend, the dust collector comprising an opening, the flow bend being formed by a partition which divides the opening into a flow bend inlet and a flow bend outlet, the partition extending part-way into the dust collector so that airflow entering through the flow bend inlet is then forced to bend around the partition inside the dust collector before exiting through the flow bend outlet.

The use of a flow bend to separate out dust in accordance with the invention provides an advantageous alternative to the use of a filter bag or a cyclonic separation stage per se. The flow bend does not require a filter bag—relying instead on inertial separation of the dust particles—and so does not suffer the problems of blocking of the filter bag and consequent loss of suction. At the same time, because it is a non-cyclonic separation stage it does not require the relatively complicated ducting associated with cyclonic separation stages, nor the use of relatively space-inefficient cyclone chambers.

The use of a flow bend in accordance with the invention is particularly advantageous in a multi-stage dust separator. The relatively simple configuration of the flow bend means that it can be packaged efficiently as a secondary stage of separation downstream of cyclonic primary stage, in particular as an intermediary stage located between the cyclonic primary and a tertiary stage of separation.

The secondary dust collector may be annular. The opening may similarly be an annular opening, preferably formed by an open upper end of the secondary dust collector. This provides for a relatively large opening to the secondary dust collector, reducing pressure losses. The partition may extend around the full circumference of the annular opening so as to define an annular flow bend inlet and an annular flow bend outlet. Again, this maximises the cross-sectional area of the flow bend inlet and the flow bend outlet to provide a full “360 degree” flow bend.

A baffle may be provided—inside the dust collector—for shielding the collected dust from the airflow around the partition, so as to limit re-entrainment of the collected dust back into the airflow. This improves the separation efficiency.

The baffle may be positioned on the outlet side of the partition for shielding the collected dust from the airflow exiting through the outlet. This helps prevent a “short-circuit” re-entrainment path directly through the outlet, which would tend to reduce separation efficiency.

The baffle may form at least part of a curved outer wall of the flow bend, which wall runs around the outside of the flow bend. The baffle thus conveniently forms an integral part of the flow bend rather than being provided separately somewhere else inside the dust collector. This maximizes useable dust collector capacity.

The partition may form at least part of a curved inner wall of the flow bend, running around the inside of the flow bend.

At least part of this inner wall of the flow bend may be concentric with the outer wall of the flow bend, helping to maintain a constant flow cross-section through the flow bend.

Preferably, the inner wall of the flow bend should curve through at least 180 degrees. This provides a beneficial effect on performance.

The baffle may comprise a guide surface for guiding air inside the secondary dust collector along a re-circulation path which is in contra-flow with the airflow through the flow bend. This helps prevent immediate re-entrainment of the separated dust back into the flow bend, improving separation efficiency.

The area of the flow bend outlet and the area of the flow bend inlet are preferably the same. This has been found to have a positive effect on separation efficiency.

The dust collector may be annular, in which case the opening may be an annular opening formed by an open upper end of the dust collector.

The partition may extend around the full circumference of the annular opening so that both the flow bend inlet and flow bend outlet are likewise annular in shape. This provides a full “360 degree” flow bend inlet and flow bend outlet, helping to reduce pressure losses through the system.

The flow bend outlet may be formed between the partition and an inner wall of the annular dust collector. In this case, the baffle may extend outwardly from the inner wall of the annular dust collector for shielding the collected dust from the airflow exiting through the flow bend outlet. This helps prevent a “short-circuit” re-entrainment path directly through the flow bend outlet.

In one embodiment, the separating apparatus comprises a cyclonic separation stage upstream of the non-cyclonic separation stage, the cyclonic separation stage comprising an annular cyclone chamber extending around the annular dust collector and a radial fin being provided inside the dust collector for inhibiting cyclonic swirl of the air inside the dust collector. This can help prevent formation of secondary flow paths in the dust collector which may lead to re-entrainment of the collected dust back into the flow bend. The fin may extend all the way across the annular diameter of the dust collector between the partition and an outer wall of the dust collector. In a preferred embodiment, the fin extends along the longitudinal axis of the dust collector at least part way into the flow bend, so as to inhibit residual cyclonic swirl of air inside the flow bend itself.

### BRIEF DESCRIPTION OF THE DRAWINGS

Embodiments of the invention will now be described with reference to the accompanying drawings, in which:

FIG. 1 is a perspective view showing a conventional bagless vacuum cleaner;

FIG. 2 is a cross-sectional view through a conventional dual-stage dust separator;

FIG. 3 is a cross-sectional view through a multi-stage dust separator according to the present invention;

FIG. 4 is a sectional view taken along A-A in FIG. 3;

FIG. 5 is a cutaway perspective view of a non-cyclonic separation stage forming part of the dust separator in FIG. 3;

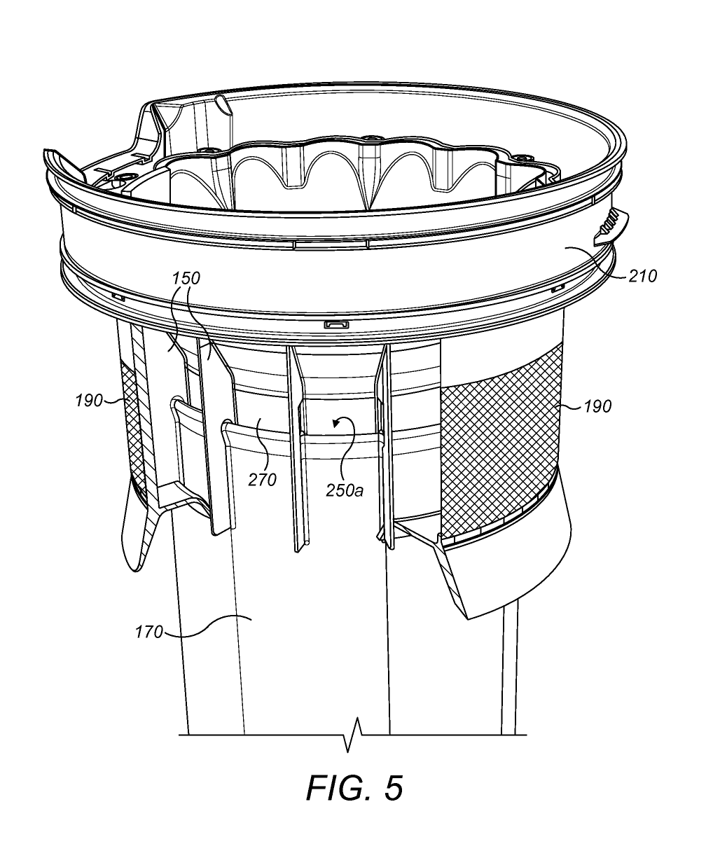

FIG. 6 is a schematic sectional view illustrating the airflow through the non-cyclonic separation stage in FIG. 5; and

FIG. 7 is a cutaway view of the non-cyclonic separation stage, showing a radial fin inside the secondary dust collector.

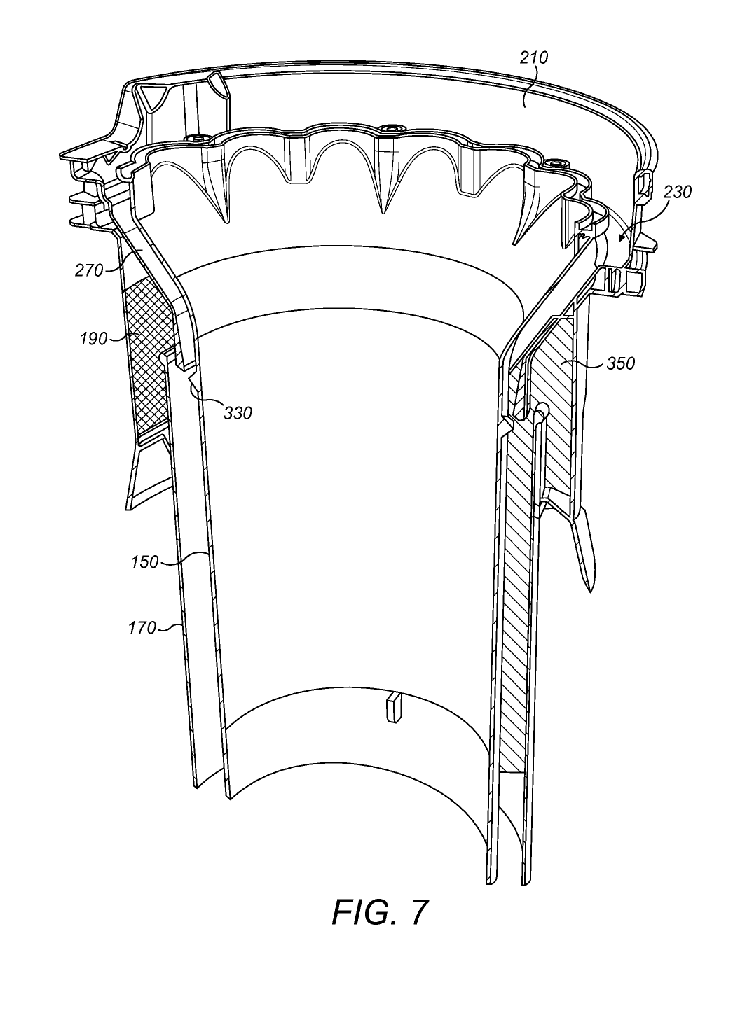

### DETAILED DESCRIPTION OF THE INVENTION

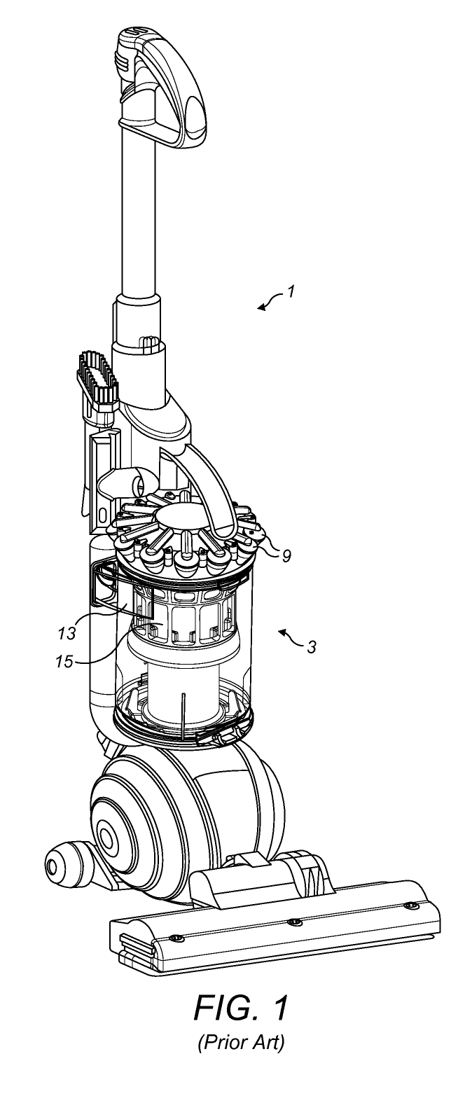

FIG. 1 illustrates a conventional vacuum cleaner 1 having a dual-stage cyclonic dust separating apparatus 3.

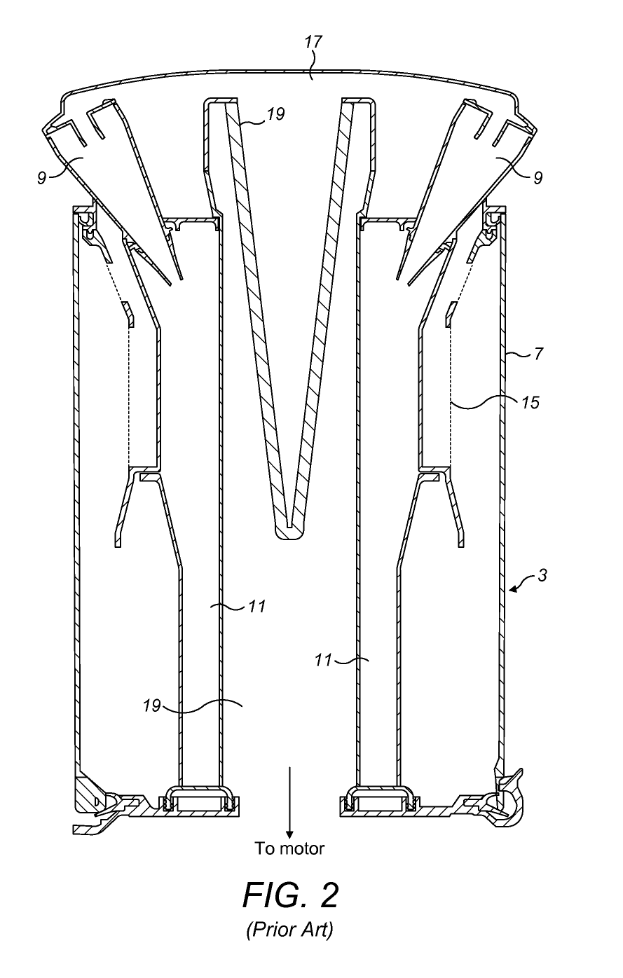

FIG. 2 is a section through the cyclonic dust separating apparatus 3. Here the first cyclonic stage—or ‘primary’—comprises a relatively large, cylindrical, outer bin 7 which acts both as a container for the primary cyclone and as a primary dust collector. The second cyclonic stage is a multi-cyclonic stage comprising a plurality of smaller, tapered cyclone chambers 9 arranged in parallel above the bin 7, which each feed into an annular secondary dust collector 11—or ‘Fine Dust Collector (FDC)’—nested inside the bin 7.

The dirty air enters the bin 7 through a tangential inlet 13 in the wall of the bin 7. This helps to impart the necessary spin to the airflow inside the bin 7, and the separated dirt collects at the bottom of the bin 7. The air exits the primary through a cylindrical mesh outlet—or ‘shroud’—15 which forms an annular duct externally around the outside of the FDC 11, leading up to the secondary cyclonic stage. The air exits the secondary cyclone chambers 9 through the top and is then collected in a manifold 17 and ducted down through the centre of the annular FDC to the vac-motor (not shown), via a sock filter 19 (for separating very fine particles still remaining in the airflow).

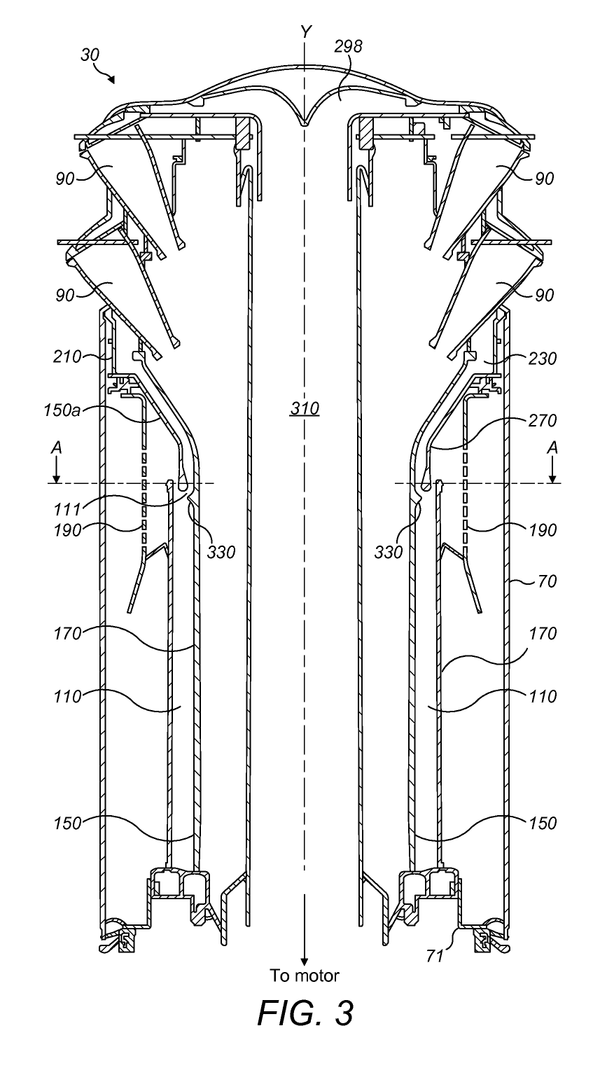

FIG. 3 is a section through a multi-stage separating apparatus 30 according to the present invention. Here, the primary cyclonic stage likewise comprises a relatively large, cylindrical bin 70, with the upper part of the bin 70 functioning as a single, annular cyclone chamber and the lower part of the bin 70 functioning as a primary dust collector. The separator 10 similarly comprises a downstream multi-cyclonic stage comprising a plurality of smaller, tapered cyclone chambers 90 arranged in two parallel tiers above the bin 70, and which feed into a dust collector 130 nested inside the bin 70. The dust collector 130 is annular and surrounds a central duct 310 which extends down from a manifold 290 connected to the air outlets of the cyclone chambers 90.

In accordance with the invention, an additional, non-cyclonic separation stage is provided in-between the primary cyclonic stage and the downstream multi-cyclonic stage. Consequently, there are three stages of separation, not two: a primary, cyclonic stage; a secondary, non-cyclonic stage and a tertiary, multi-cyclonic stage.

The secondary, non-cyclonic stage of separation comprises an annular, secondary dust collector 110 and a non-cyclonic dust separator, both of which are housed inside the bin 70.

The secondary dust collector 110 surrounds the tertiary dust collector 130. The secondary dust collector 110 and tertiary dust collector 130 share a common dividing wall 150, which constitutes both the outer wall of the tertiary dust collector 130 and the inner wall of the secondary dust collector 110. This common dividing wall 150 extends the full length of the bin 70 and incorporates a flared upper section 150a for accommodating the lower ends of some of the cyclone chambers 90.

The outer wall 170 of the secondary dust collector 110 extends only part way up the bin 70 and so defines an annular opening 111 between the outer wall 170 of the secondary dust collector 110 and the inner wall of the secondary dust collector (i.e. the common dividing wall 150). The outer wall 170 of the secondary dust collector 110 constitutes a common dividing wall between the secondary dust collector 110 and the surrounding primary dust collector at the bottom of the bin 70.

The three dust collectors 70, 110, 130 are open at their lower ends. The open lower ends are partitioned by the respective common dividing walls 150, 170. A common, hinged cover member 71 is provided which closes off the open lower ends of the dust collectors 70, 110, 130 for simultaneous emptying of the three collectors 70, 110, 130. The cover member 71 seals against the two common dividing walls 150, 170, the wall of the perimeter wall of the bin 70 and the wall of the duct 310.

A sealing collar 210 is located around the inside of the upper end of the bin 70. This sealing collar 210 defines an annular duct 230 around the outside of the tertiary dust collector 130, which leads up to the multiple inlets of the cyclones 90.

A cylindrical mesh shroud 190 encloses the open upper end of the secondary dust collector 110. The shroud 190 is fixed near its lower end to the outer wall 170 of the secondary dust collector 110 and at its upper end to the collar 210.

The secondary non-cyclonic dust separator comprises a flow bend 250 inside the second dust collector 110 for changing the direction of the airflow thereby to separate out dust particles from the airflow. The flow bend 250 is formed by a partition 270 which extends concentrically around the outside of the tertiary dust collector 130, behind the shroud 190. An upper end of the partition 270 is fixed to the collar 210 and the partition 270 extends down from the collar 210 to form an extension of the annular duct 230. The partition 270 extends down through the annular opening 111 and part way into the secondary dust collector 110. The partition 270 thus divides the annular opening 111 into an annular flow bend inlet 250a which connects upstream to the inside of the bin 70 through the shroud 190, and an annular flow bend outlet 250b which connects downstream to the annular duct 230. The lower end of the partition 270 is profiled to form a tapered inlet section 250c of the flow bend 250 immediately downstream of the flow bend inlet 250a and a reverse-tapered outlet section 250d of the flow bend 250 immediately upstream of the flow bend outlet 250b. In the middle section of the flow bend 250, between the two tapered sections 250c, 250d, the partition 270 is radiused to form a curved inner wall 250e of the flow bend 250.

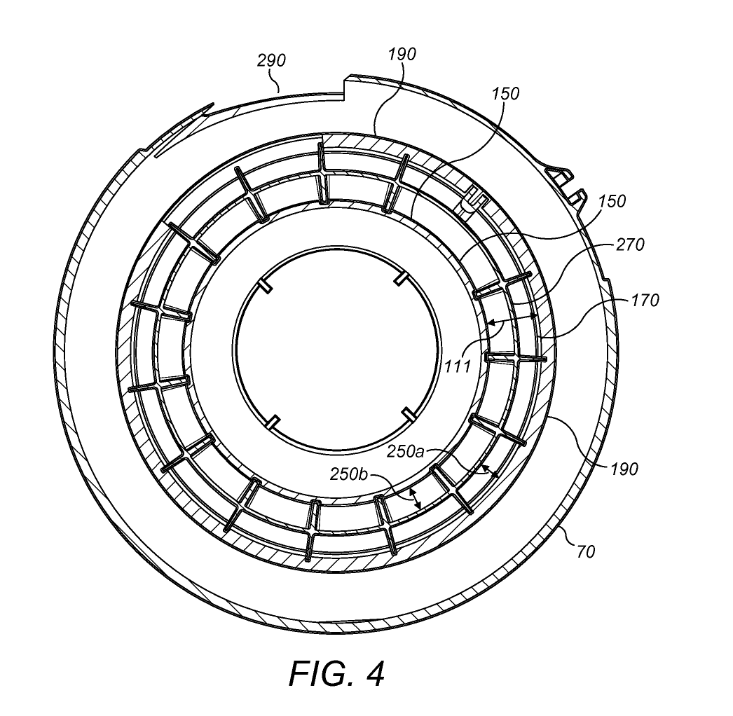

In use, the dirty airflow enters the separating apparatus 30 through a tangential inlet 298 (FIG. 4) in the wall of the bin 70. Low efficiency cyclonic separation takes place inside the bin 70 (owing to its relatively large radius) which separates out relatively large dust particles from the airflow. These large dust particles collect in the bottom of the bin 70. The airflow then exits the primary cyclonic stage through the mesh shroud 190 and enters the secondary non-cyclonic stage. In the secondary stage, the airflow enters the flow bend 250 through the flow bend inlet 250a and is then forced to bend around the partition 270 inside the secondary dust collector 110 before exiting through the flow bend outlet 250b. The two tapered sections 250c, 250d of the flow bend 250 combine to accelerate the airflow into the flow bend 250 and then decelerate the airflow exiting the flow bend 250.

This relatively rapid change in the velocity of the airflow around the partition 270 separates out intermediate-size dust particles still entrained in the airflow. The dust separated out by the flow bend 250 is then collected in the secondary dust collector 110.

Airflow exiting the flow bend 250 is ducted up to the tertiary cyclonic stage via the annular duct 230 where it is distributed between the cyclone chambers 90. High efficiency cyclonic separation takes place inside these cyclone chambers (owing to their relatively small radius) which separates out fine dust particles still entrained in the airflow after it exits the secondary stage. These separated fine dust particles are then collected in the tertiary dust collector 130.

The clean airflow exits the tertiary cyclonic stage and is then ducted to the vac-motor via the common manifold 290 and associated ducting 310.

As and when required, the three dust collectors 70, 110, 130 are emptied simultaneously by manually opening the hinged cover member 71.

There is no filter in the separating apparatus 30. Instead, fine particulates are separated out by the tertiary cyclonic stage. This is made possible through introduction of the secondary non-cyclonic separator which removes intermediate-size dust particles upstream of the cyclone chambers 90. Consequently, the cyclone chambers 90 can be designed with a tight chamber-radius for relatively high-efficiency separation of very fine particulates, without risk of being overloaded with intermediate size dust particles. This is achieved using a space efficient, non-cyclonic arrangement of secondary separator which does not suffer the drawbacks of filter bags (or filters generally).

Any reduction in chamber radius for the tertiary cyclone chambers 90 will tend to increase the pressure drop across the tertiary stage. However, this is offset by increasing the number of parallel cyclone chambers 90 in the tertiary stage. The chambers 90 are nevertheless packaged in a space-efficient manner by ‘stacking’ the parallel cyclone chambers in tiers, one on top of the other, as shown in FIG. 3—see also UK Patent Publication No. GB2475312.

A baffle 330 is provided inside the secondary dust collector 110 for shielding the collected dust 112 inside the secondary dust collector 110 from the airflow passing around the partition 270. This prevents re-entrainment of the collected dust back into the flow bend 250, improving separation efficiency.

The baffle 330 is provided on the inner wall 150 of the secondary dust collector 110, on the outlet side of the partition 270: for shielding the collected dust from the airflow exiting the flow bend outlet 250b. This helps prevent a “short-circuit” re-entrainment path directly through the flow bend outlet 250b.

The baffle 330 is located in proximity to the partition 270. The upper surface of the baffle 330 is scooped to form a curved outer wall 250f of the flow bend 250. This curved outer wall 250f of the flow bend 250 is generally concentric with the inner wall 250e of the flow bend 250. This helps maintain a stable mean velocity for the airflow as it bends around the lower edge of the partition 270.

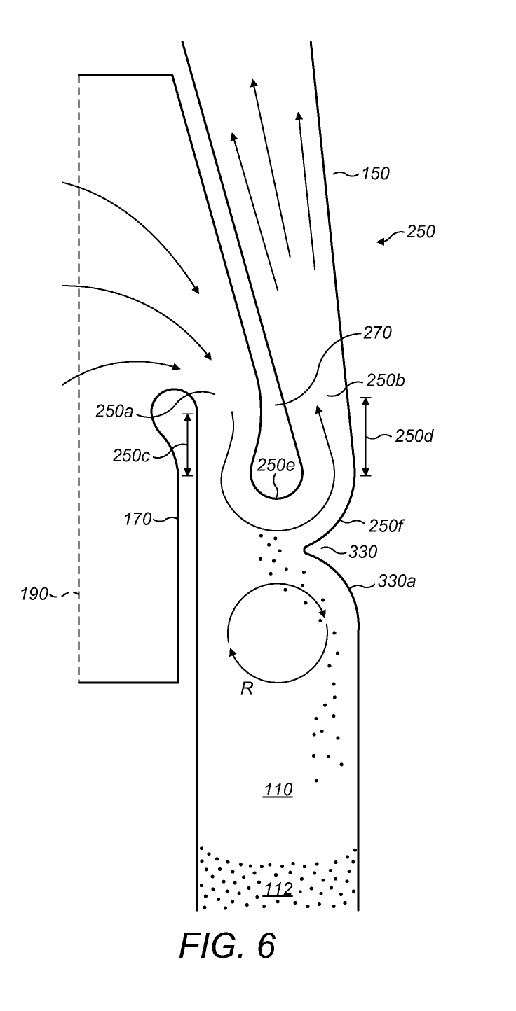

The underside of the baffle 330 is also scooped, to form a guide surface 330a. This guide surface 330a promotes a re-circulation path R for the air inside the secondary dust collector 110, which re-circulation path is in contra-flow with the airflow through the flow bend 250 (see FIG. 6). Consequently, dust which is separated out in the flow bend 250 tends to be dragged down into the secondary collector 110 by the re-circulating flow A inside the secondary dust collector 110. This reduces the chance of immediate re-entrainment of the dust back into the flow bend 250, improving separation efficiency.

The air exiting the primary may maintain a degree of residual cyclonic swirl about the axis Y which may, at least in certain circumstances, compromise the specific performance of the flow bend 250. To inhibit this swirl, a series of radial fins 350 are provided inside the secondary dust collector 110, extending along the axis Y. The radial fins 350 span the annular diameter of the secondary dust collector 110, effectively to partition the secondary dust collector 110 into separate compartments. The radial fins 350 extend up into the flow bend 250, thus also partitioning the flow bend 250 to inhibit residual cyclonic swirl about the axis Y inside the flow bend 250 itself. Smaller fins may be provided which nevertheless inhibit the residual swirl of the airflow, at least to a degree. For example, fins may be provided only in the flow bend 250 itself, but which do not extend down further into the secondary dust collector 110.

1. A vacuum cleaner comprising a vac motor and a separating apparatus for separating out dust particles entrained in an airflow drawn through the separating apparatus by the vac motor, the separating apparatus comprising a non-cyclonic separation stage, the non-cyclonic separation stage comprising a flow bend for turning the airflow to separate out some of the dust particles entrained in the airflow, and a dust collector for collecting the dust particles separated out by the flow bend, the dust collector comprising an opening, the flow bend being formed by a partition which divides the opening into a flow bend inlet and a flow bend outlet, the partition extending part-way into the dust collector so that airflow entering through the flow bend inlet is then forced to bend around the partition inside the dust collector before exiting through the flow bend outlet.

2. The vacuum cleaner of claim 1, in which a baffle is provided for shielding the collected dust from the airflow around the partition so as to limit re-entrainment of the collected dust back into that airflow.

3. The vacuum cleaner of claim 2, in which the baffle is positioned on the outlet side of the partition for shielding the collected dust from the airflow exiting through the outlet.

4. The vacuum cleaner of claim 2, wherein the baffle forms at least part of a curved outer wall of the flow bend, which wall runs around the outside of the flow bend.

5. The vacuum cleaner of claim 4, wherein the partition forms a curved inner wall of the flow bend, running around the inside of the flow bend, at least part of this inner wall of the flow bend being concentric with said part of the outer wall of the flow bend.

6. The vacuum cleaner of claim 5, in which the inner wall of the flow bend curves through at least 180 degrees.

7. The vacuum cleaner of claim 2, wherein the baffle comprises a guide surface for guiding air inside the secondary dust collector along a re-circulation path which is in contra-flow with the airflow through the flow bend.

8. The vacuum cleaner of claim 1, in which the area of the flow bend outlet and the area of the flow bend inlet are the same.

9. The vacuum cleaner of claim 2, wherein the dust collector is annular.

10. The vacuum cleaner of claim 3, wherein the opening is an annular opening formed by an open upper end of the dust collector.

11. The vacuum cleaner of claim 4, wherein the partition extends around the full circumference of the annular opening so that both the flow bend inlet and flow bend outlet are likewise annular in shape.

12. The vacuum cleaner of claim 9, in which the flow bend outlet is formed between the partition and an inner wall of the annular dust collector.

13. The vacuum cleaner of claim 10, wherein the baffle extends outwardly from the inner wall of the annular dust collector for shielding the collected dust from the airflow exiting through the flow bend outlet.

14. The vacuum cleaner of claim 9, wherein the separating apparatus comprises a cyclonic separation stage upstream of the non-cyclonic separation stage, the cyclonic separation stage comprising an annular cyclone chamber extending around the annular dust collector and a radial fin being provided inside the dust collector for inhibiting cyclonic swirl of the air inside the dust collector.

15. The vacuum cleaner of claim 14, wherein the fin extends radially all the way across the annular dust collector.

16. The vacuum cleaner of claim 14, wherein the fin extends along the longitudinal axis of the dust collector at least part way into the flow bend for inhibiting residual cyclonic swirl of the air flowing through the flow bend.

17. The vacuum cleaner of claim 16, wherein the fin extends all the way into the flow bend at least as far as the opening in the dust collector.

18. The vacuum cleaner of claim 1, wherein the dust collector is arranged substantially vertically.
